(19) United States
(12) Patent Application Publication
(10) Pub. No.: US 2010/0287194 A1
(43) Pub. Date: Nov. 11, 2010

(54) PRESENCE-AT-HOME INFORMATION ACQUISITION SYSTEM

(76) Inventor: Masafumi Watanabe, Tokyo (JP)

Correspondence Address: Mr. Jackson Chen, 6535 N. STATE HWY 161, IRVING, TX, 75039, US

(21) Appl. No.: 12/810,880

(22) PCT Filed: Dec. 25, 2008
(86) PCT No.: PCT/JP2008/073646

§ 371 Date: Jun. 28, 2010

(30) Foreign Application Priority Data
Dec. 28, 2007 (JP) 2007-338886

(51) Int. Cl. G06F 17/30

(52) U.S. Cl. 707/769; 707/802; 707/E17.005; 707/E17.014

(57) ABSTRACT

A presence-at-home information acquisition system is provided with an identifier table update means and a presence-at-home information distribution control means. When a user inputs permission to acquire presence-at-home information on the user, an identifier table update means stores a first identifier for identifying the user and a second identifier designated by a request for acquisition of the presence-at-home information in an identifier table storage means, with both identifiers associated with each other. The presence-at-home information distribution control means judges whether or not the second identifier is stored in the identifier table storage means. When judging that the second identifier is stored, the presence-at-home information distribution control means acquires the presence-at-home information on the user specified by the first identifier associated with the second identifier from the presence-at-home information storage means.

### TECHNICAL FIELD

The present invention relates to a presence-at-home information acquisition system, method and program; and more particularly to a presence-at-home information acquisition system, method and program that acquire and provide presence-at-home information of a user.

### BACKGROUND ART

In a home delivery system, the efficiency of a home delivery business to utilize presence-at-home information of a recipient is improving (for example, refer to Patent Literatures 1 to 5). The status of whether or not a recipient is at home is information related to the recipient's privacy, so it is necessary that disclosure to the driver be kept to a minimum. In regards to this, a system is known (refer to Patent Literature 2) that acquires the status of whether or not a recipient is at home by placing an automatic telephone call when entering within a fixed distance from the delivery location.

### Patent Literature 1: Unexamined Japanese Patent Application KOKAI Publication No. 2002-135445

### Patent Literature 2: Unexamined Japanese Patent Application KOKAI Publication No. 2004-231402

### Patent Literature 3: Unexamined Japanese Patent Application KOKAI Publication No. 2005-255306

### Patent Literature 4: Unexamined Japanese Patent Application KOKAI Publication No. 2006-244401

### Patent Literature 5: Unexamined Japanese Patent Application KOKAI Publication No. 2007-094641

### DISCLOSURE OF THE INVENTION

In Patent Literature 3, presence-at-home information, which indicates the status of whether or not a recipient will be at home during the delivery time period, is set in package related information that is stored in a package related information database, and by referencing that package related information, a delivery person can determine whether or not the recipient is at home. With this system, it is necessary to set presence-at-home information in the package related information for each package, so, for example, when there are more than one package to be delivered at the same time, it is necessary to set the presence-at-home information for each individual package. Therefore, the burden on the recipient becomes large. On the other hand, a method is also feasible in which presence-at-home information is set for the recipient, and the delivery person searches presence-at-home information based on a recipient identifier. However, after the recipient identifier has been given to the delivery person, the delivery person can access the presence-at-home information of the recipient regardless of whether or not there is a package for the recipient. This is not preferable from the aspect of protection of privacy. In addition, it is not possible to control whether or not to allow disclosure of the presence-at-home information for each individual package.

The object of the present invention is to provide a presence-at-home information acquisition system, method and program that are capable of protecting a user's privacy while at the same time easing the work burden.

### MEANS FOR SOLVING THE PROBLEMS

The present invention provides a presence-at-home information acquisition system comprising: an identifier table update means that, when the user performs input allowing acquisition of the user's presence-at-home information, correlates and stores a first identifier for identifying a user and a second identifier that is specified in an acquisition request for presence-at-home information in an identifier table storage means that correlates and stores the first identifier and second identifier; and a presence-at-home information distribution control means that determines whether or not the second identifier is stored in the identifier table storage means, and when it is determined that the second identifier is stored, acquires presence-at-home information from a presence-at-home information storage means that stores the presence-at-home information of the user specified by the first identifier that corresponds to the second identifier.

Moreover, the present invention provides a recipient terminal comprising: an information confirmation means of prompting a user to input information that specifies whether or not to allow acquisition of presence-at-home information; and an identifier table update means that, when the user performs input allowing acquisition of the user's presence-at-home information, correlates and stores a first identifier for identifying a user and a second identifier that is specified in an acquisition request for presence-at-home information in an identifier table storage means that correlates and stores the first identifier and second identifier.

Furthermore, the present invention provides a presence-at-home information server comprising a presence-at-home distribution control means that determines whether or not a second identifier is stored in an identifier table storage means that correlates and stores a first identifier for identifying a user and a second identifier that is specified in an acquisition request for presence-at-home information, and when it is determined that the second identifier is stored, acquires presence-at-home information of that user from a presence-at-home information storage means that stores the presence-at-home information of the user.

The present invention also includes a method of using a computer to provide presence-at-home information that indicates whether a user can receive a visit, comprising the steps of: the computer correlating and storing a first identifier for identifying the user, and a second identifier that is specified by an acquisition request for presence-at-home information in an identifier table storage means when the user performs input allowing the acquisition of the presence-at-home information; the computer determining whether or not the second identifier is stored in the identifier table storage means; and the computer acquiring presence-at-home information from the presence-at-home information storage means, which stores the presence-at-home information, of the user identified by the stored first identifier that corresponds to the second identifier when it is determined in the judgment step that the second identifier is stored.

Moreover, the present invention includes a program for providing presence-at-home information that indicates whether a user can receive a visit, and that causes a computer to execute the processes of: correlating and storing a first identifier for identifying the user, and a second identifier that is specified by an acquisition request for presence-at-home information in an identifier table storage means when the user performs input allowing the acquisition of the presence-at-home information; determining whether or not the second identifier is stored in the identifier table storage means; and acquiring presence-at-home information from the presence-at-home information storage means, which stores the presence-at-home information, of the user identified by the stored first identifier that corresponds to the second identifier when it is determined in the judgment step that the second identifier is stored.

### EFFECT OF THE INVENTION

The presence-at-home information acquisition system, method and program are capable of obtaining the advantageous effect of protecting the privacy of a user, while at the same time reducing the workload on the user.

The aforementioned as well as other objects, features and advantages of the present invention will be made clear from the following explanation with reference to the accompanying drawings.

### BRIEF DESCRIPTION OF THE DRAWINGS

FIG. 1 is a block diagram of a presence-at-home information acquisition system of a first embodiment of the present invention;

FIG. 2 is a diagram illustrating in detail an identifier table;

FIG. 3 is a flowchart illustrating the operating procedure when inputting package information;

FIG. 4 is a flowchart illustrating the operating procedure when displaying presence-at-home information;

FIG. 5 is a flowchart illustrating the operating procedure when receiving a package;

FIG. 6 is a block diagram of a presence-at-home information acquisition system of a second embodiment of the present invention;

FIG. 7 is a diagram illustrating a detailed example of information selection rules;

FIG. 8 is a flowchart illustrating the operating procedure when acquiring presence-at-home information; and

FIG. 9 is a block diagram of a variation of the first embodiment.

### BEST MODES FOR CARRYING OUT THE INVENTION

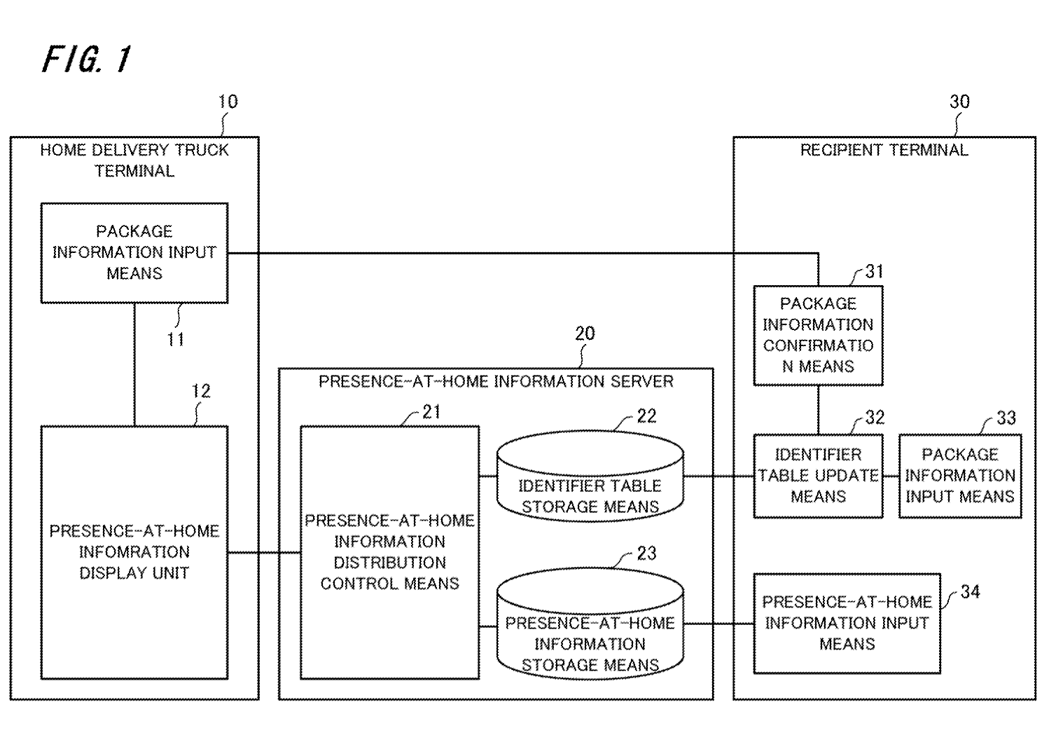

In the following, the preferred embodiments of the present invention will be explained with reference to the accompanying drawings. In the drawings, the same reference numbers will be used for elements that are common in all drawings. FIG. 1 illustrates the configuration of a presence-at-home information acquisition system of a first embodiment of the present invention. The presence-at-home information acquisition system comprises a delivery truck terminal 10, a presence-at-home information server 20 and a recipient terminal 30. The delivery truck terminal 10 is located in a delivery truck that is used for performing delivery work, and the recipient terminal 30 is located at the home or the like of the recipient of a package. These terminals may also be mobile terminals that are carried by the driver or recipient. The presence-at-home information terminal 20 is located at a center such as the package distribution station. All of the functions of the delivery truck terminal 10, presence-at-home server 20 and recipient terminal 30 are realized by a computer executing specified programs, for example.

The delivery truck terminal 10 comprises a package information input means (delivery-side package information input means) 11 and a presence-at-home information display unit 12. The package information input means 11 comprises an input device such as a barcode reader or RFID (Radio Frequency Identification) reader. A label on which a barcode is printed, or an RFID tag is applied to a package. Using the input device, the driver inputs package information for a package to be delivered to the package information input means 11. The package information includes a package identifier, the name of the sender, the name of the recipient, contact information of the recipient, and the like. In the present invention, the term ‘package’ is not limited to a narrow definition of the term package, and may include anything that is included in the concept of a ‘package’ such as envelopes and other articles.

After package information has been inputted, the package information input means 11 gives the inputted package information to the presence-at-home information display unit 12. In addition, the package information input means 11 references the contact information of the recipient, and sends a confirmation request. The confirmation request may include the package identifier and information related to the package, for example, information about the sender and the like. When an e-mail address is used as the contact information for the recipient, for example, the package information input means 11 extracts the e-mail address of the recipient from the package information and sends a confirmation request e-mail to that e-mail address. Instead of e-mail, a method of communication such as an instant message may also be used.

The presence-at-home information display unit 12 receives package information from the package information input means 11, and stores that received package information in a memory device. The presence-at-home information display unit 12 comprises an input device such as buttons or a touch panel, and by using the input device, a request is received from a driver (delivery person) to display presence-at-home information. After receiving the display request from the driver to display presence-at-home information, the presence-at-home information display unit 12 sends the package identifier that is included in the stored package information to the presence-at-home information server 20, and requests acquisition of the presence-at-home information of the package recipient that corresponds to the sent package identifier. After acquiring the presence-at-home information from the presence-at-home information server 20, the presence-at-home information display unit 12 displays the acquired presence-at-home information to the driver by way of an output device such as a liquid-crystal display.

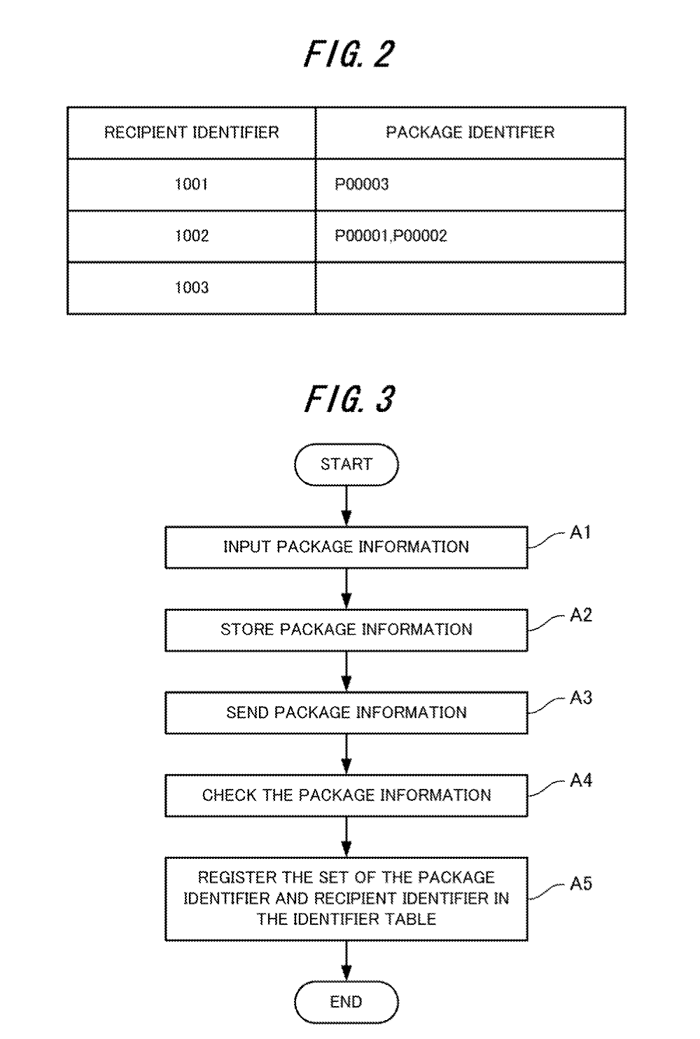

The presence-at-home information server 20 has a presence-at-home information distribution control means 21, an identifier table storage means 22 and presence-at-home information storage means 23. The presence-at-home information storage means 23 stores presence-at-home information of a recipient that is identified by a recipient identifier. The presence-at-home information includes information that indicates whether or not a recipient is able to receive a visit. Here, when the recipient is able to receive a visit, the status becomes ‘available’, and when the recipient is unable to receive a visit, the status becomes ‘not-available’. The identifier table storage means 22 stores an identifier table that correlates the recipient identifiers (first identifiers) with package identifiers (second identifiers). FIG. 2 illustrates a detailed example of an identifier table. By referencing this identifier table, it is possible to find the identifier of a recipient of a package from the package identifier.

The presence-at-home information distribution control means 21 references the identifier table storage means 22 and presence-at-home information memory means 23, and returns presence-at-home information of the package recipient, which corresponds to the package identifier that was sent from the presence-at-home information display unit 12, to the presence-at-home information display unit 12. More specifically, after receiving a package identifier from the presence-at-home information display unit 12, the presence-at-home information distribution control means 21 references the identifier table storage means 22, and determines whether or not the received package identifier has been registered in the identifier table memory means 22. When the package identifier in question is registered in the identifier table storage means 22, the presence-at-home information distribution control means 21 acquires the registered recipient identifier that corresponds to that package identifier. After that, the presence-at-home information distribution control means 21 references the presence-at-home information storage means 23, acquires the registered presence-at-home information for the acquired recipient identifier, and sends the acquired presence-at-home information to the presence-at-home information display unit 12. When the package identifier that is received from the presence-at-home information display unit 12 is not registered in the identifier table storage means 22, the presence-at-home information distribution control means 21 is not able to acquire the recipient identifier for the package that corresponds to the package identifier, so that it returns error information to the presence-at-home information display unit 12.

The recipient terminal 30 has a package information confirmation means 31, identifier table update means 32, package information input means (recipient-side package information input means) 33 and a presence-at-home information input means 34. The package information confirmation means 31 receives a confirmation request e-mail from the package information input means 11, and sends information related to the package that is included in the confirmation request e-mail to the recipient. In addition, the package information confirmation means 31 prompts the recipient to input confirmation results of whether or not it is okay to disclose the presence-at-home information related to the delivery of the package corresponding to the package identifier included in the confirmation request e-mail to the driver.

The package information confirmation means 31 is provided with an input device such as buttons. After the recipient operates the input device and inputs the confirmation result, the package information conformation means 31 gives the confirmation result and the package identifier to, the identifier table update means 32. The identifier table update means 32 receives the confirmation result and the package identifier from the package information confirmation means 31. When the confirmation result allows disclosure of the presence-at-home information, the identifier table update means 32 adds and registers the recipient identifier and package identifier in the identifier table storage means 22 in the presence-at-home server 20. At this time, when there is a plurality of packages for which disclosure of presence-at-home information is allowed, a plurality of package identifiers can be given to the identifier table update means 32 from the package information confirmation means 31, and the plurality of package identifiers can be registered in the identifier table storage means 22.

When the recipient inputs presence-at-home information, or in other words, inputs information indicating whether or not the recipient can respond to a visit, the presence-at-home information input means 34 stores that presence-at-home information together with the recipient identifier in the presence-at-home information storage means 23 in the presence-at-home information server 20. The presence-at-home information is inputted using an input device that can switch between ‘at home’ and ‘not at home’ by pressing a button, or the recipient can input the presence-at-home information by operating a personal computer keyboard, for example, or by placing sensors in the home, and information that indicates whether the recipient is ‘at home’ or ‘not at home’ can be input by whether or not the sensors detect people. When doing this, sensors can be placed at several locations in the home, and detailed information that indicates where in the home the recipient is can be added to the presence-at-home information. In that case, even though the recipient is at home, when the recipient is in the bath, for example, information indicating that the recipient is unavailable for a visit can be registered in the presence-at-home information storage means 23. When presence-at-home information of the recipient that is identified by the recipient identifier is already stored in the presence-at-home information storage means 23, the presence-at-home input means 34 is updated with the new inputted presence-at-home information.

The package information input means 33 comprises an input device such as a barcode reader or RFID tag reader. The recipient holds the barcode reader over a label on which a barcode is applied, and inputs the package identifier of the received package into the package information input means 33. After the package identifier of the package received by the recipient has been inputted, the package information input means 33 gives the inputted package identifier to the identifier table update means 32. When the package identifier is received from the package information input means 33, the identifier table update means 32 deletes the set comprising that package identifier and the recipient identifier that corresponds to that package identifier from the identifier table storage means 22.

In the following, the operation procedure of this embodiment will be explained. First, the operation when inputting package information will be explained. The package information is inputted when the driver of the delivery truck, for example, loads packages into the delivery truck at the package distribution center. FIG. 3 illustrates the operating procedure when inputting package information. The driver uses the package information input means 11 to input the package information (step A1). The package information input means 11 gives the inputted package information to the presence-at-home information display unit 12. The presence-at-home information display unit 12 stores the received package information (step A2). The package information input means 11 sends a confirmation request e-mail to the e-mail address that is included in the package information that was inputted in step A1 (step A3).

The package information confirmation means 31 of the recipient terminal 30 receives the confirmation request e-mail that was sent in step A3. The package information confirmation means 31 uses the output device to display information related to the package that was included in the confirmation request e-mail to the recipient. The package information confirmation means 31 requests confirmation from the recipient of whether or not disclosure of the recipient's presence-at-home information related to the delivery of the package in question to the driver is allowed (step A4). The recipient checks the name of the sender of the package, and determines whether or not to allow disclosure of the presence-at-home information. After that, in response to the confirmation request, the recipient uses the input device of the package information confirmation means 31 to input whether to ‘allow’ or ‘not allow’ disclosure of the presence-at-home information.

After the recipient has inputted the confirmation result, the package information confirmation means 31 gives the inputted confirmation result and the package identifier to the identifier table update means 32. The identifier table update means 32 receives the confirmation result and package identifier from the package information confirmation means 31 and determines whether or not the confirmation result allows disclosure of the presence-at-home information. When disclosure of the presence-at-home information is allowed, the identifier table update means 32 adds and registers the set of recipient identifier and package identifier in the identifier table storage means 22 of the presence-at-home information server 20 (step A5). When disclosure of the presence-at-home information is not allowed, registration in the identifier table storage means 22 is not performed.

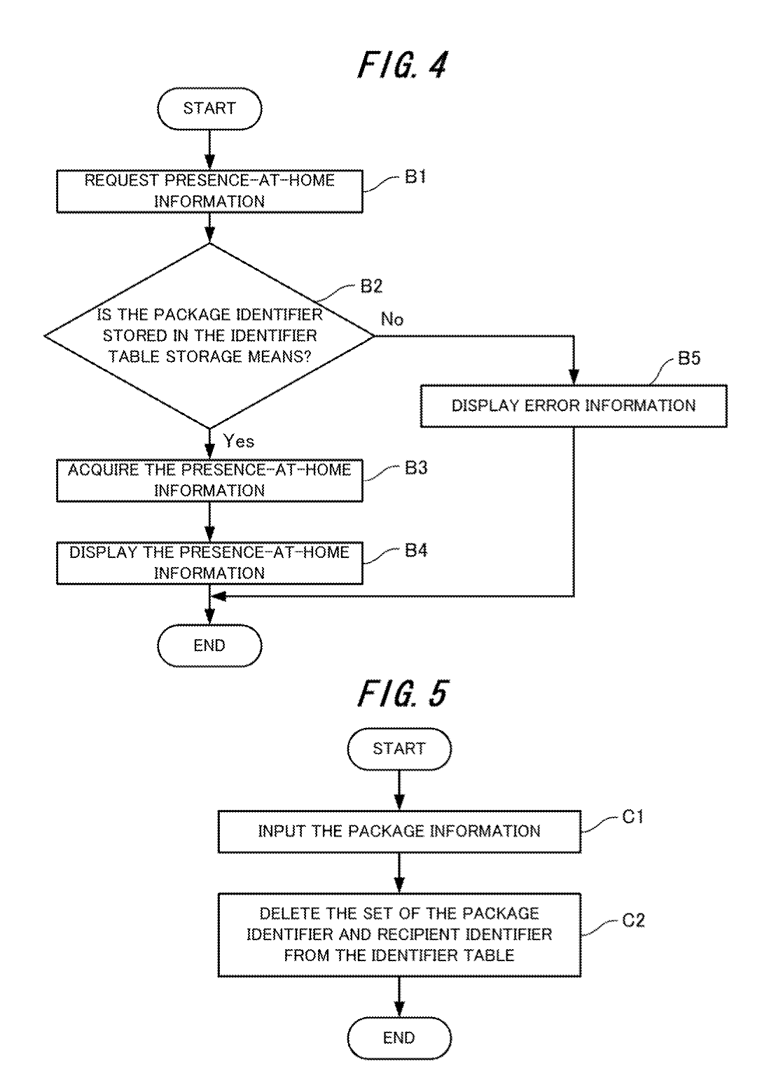

Next, the operating procedure when the driver uses the delivery truck terminal 10 to display the presence-at-home information will be explained. FIG. 4 illustrates the operating procedure when displaying the presence-at-home information. After the package information has been inputted, the driver, at arbitrary timing, inputs a display request (acquisition request) to the package information display means 12 to display the presence-at-home status. The presence-at-home display request can be performed for all of the packages at once, or can be performed for each individual package. The presence-at-home information display unit 12 receives the presence-at-home information display request from the driver that was inputted from the input device (step B1). After the driver has inputted the presence-at-home display request from the input device, the presence-at-home information display unit 12 gives the package identifier, which is included in the package information that was stored in step A2 of FIG. 3, to the presence-at-home information distribution control means 21 of the presence-at-home information server 20. After receiving the package identifier from the presence-at-home information display unit 12, the presence-at-home information distribution control means 21 references the identifier table storage means 22 and determines whether or not the received package identifier is registered (step B2).

When the package identifier that was received from the presence-at-home display means 12 is stored in the identifier table storage means 22, the presence-at-home distribution control means 21 acquires the registered recipient identifier that is correlated with the package identifier from the identifier table storage means 22. After that, the presence-at-home distribution control means 21 references the presence-at-home information storage means 23, acquires the registered presence-at-home information that is correlated with the recipient identifier that was acquired in step B3, and gives the acquired presence-at-home information to the presence-at-home information display unit 12 (step B3). The presence-at-home information display unit 12 displays the presence-at-home information that was received from the presence-at-home information distribution control means 21 by way of the output device, and presents information to the driver indicating whether or not the recipient of the package in question can receive a visit (step B4). When the package identifier that was received from the presence-at-home, information display unit 12 is not stored in the identifier table storage means 22, the presence-at-home information distribution control means 21 returns an error to the presence-at-home information display unit 12 indicating that the presence-at-home information could not be acquired. In that case, the presence-at-home information display unit 12 shows an error message by way of the output device (step B5). Or, a display indicating that the presence-at-home information cannot be acquired is displayed.

Continuing, the operating procedure when the recipient receives the package will be explained. FIG. 5 illustrates the operating procedure when a package is received. When receiving a package, the recipient uses the input device to input the package identifier of that package to the package information input means 33 (step C1). The package information input means 33 gives the inputted package identifier to the identifier table update means 32. After receiving the package identifier, the identifier table update means 32 deletes the set of package identifier and recipient identifier that corresponds to that package identifier from the identifier table storage means 22 of the presence-at-home information server 20 (step C2).

In this embodiment, when recipient inputs an indication allowing the disclosure of presence-at-home information, the package identifier and recipient identifier are correlated and stored in the identifier table storage means 22. When the driver generates a request to display presence-at-home information, the presence-at-home information distribution control means 21 references the identifier table storage means 22, acquires the recipient identifier, and uses the acquired recipient identifier to acquire the presence-at-home information for the recipient from the presence-at-home information storage means 23. In other words, in this embodiment, using the identifier table storage means 22, the presence-at-home information of the recipient and the identifier of the package delivered are linked, and the reference access of the presence-at-home information of the recipient by the driver is controlled. In this embodiment, because it is not necessary to give the recipient identifier to the driver, it is possible to protect the privacy of the recipient.

Moreover, in this embodiment, when disclosure of the presence-at-home information is allowed, the set of the package identifier and the recipient identifier are stored in the identifier table storage means 22. By the recipient using the recipient terminal 30 to register the recipient identifier in the identifier data storage means 22, the driver is then able to access the presence-at-home information. Therefore, the recipient is freely able to control whether to ‘allow’ or ‘not allow’ disclosure of the presence-at-home information. Furthermore, this embodiment employs a method of controlling reference access to presence-at-home information using a set of package identifier and recipient identifier, so that the recipient is able to allow disclosure of presence-at-home information for a certain package, and not allow disclosure of presence-at-home information for a different package. That is, the recipient is able to set whether to ‘allow’ or ‘not allow’ disclosure of presence-at-home information for individual packages to be received. When doing this, the recipient does not have to input presence-at-home information for each individual package. Therefore, the burden of work on the recipient side does not increase.

When disclosing presence-at-home information, it is preferred that in the case where the driver intentionally dispatches a package, the driver not be able to know the status of whether or not the recipient is at home. Moreover, in the case where the driver improperly inputs presence-at-home information, it is preferred that the driver not be able to know the status of whether or not the recipient is at home. In this embodiment, by using a confirmation request e-mail, information related to a package to be received by a recipient is sent to the recipient, and prompts the user to input whether to ‘allow’ or ‘not allow’ disclosure of presence-at-home information for that package. In the case of an unexpected package or a package that was sent from an unknown sender, by not registering the package identifier, the recipient is able to not allow disclosure of presence-at-home information to the driver. Therefore, even in the case where the driver attempts to improperly acquire presence-at-home information of a recipient by intentionally delivering a package, or improperly inputting package information, it is possible to prevent disclosure of presence-at-home information.

Furthermore, in this embodiment, after receiving a package, the recipient deletes the set of the recipient identifier and the package identifier of the received package from the identifier table storage means 22. After the package identifier has been deleted, even though a driver requests the display of presence-at-home information, an error is returned because the package identifier is not registered in the identifier table storage means 22, and the driver is not notified of the presence-at-home information of the recipient. In the case where the driver registers or deletes the package identifier, it is possible to not delete the package identifier even after the delivery is completed, and in that case, the driver is able to continue to reference the presence-at-home information of the recipient. In this embodiment, after a package is received, the recipient deletes the package identifier from the identifier table storage means 22, so that it is possible to prevent disclosure of the presence-at-home information of the recipient to a driver for the package after delivery is complete.

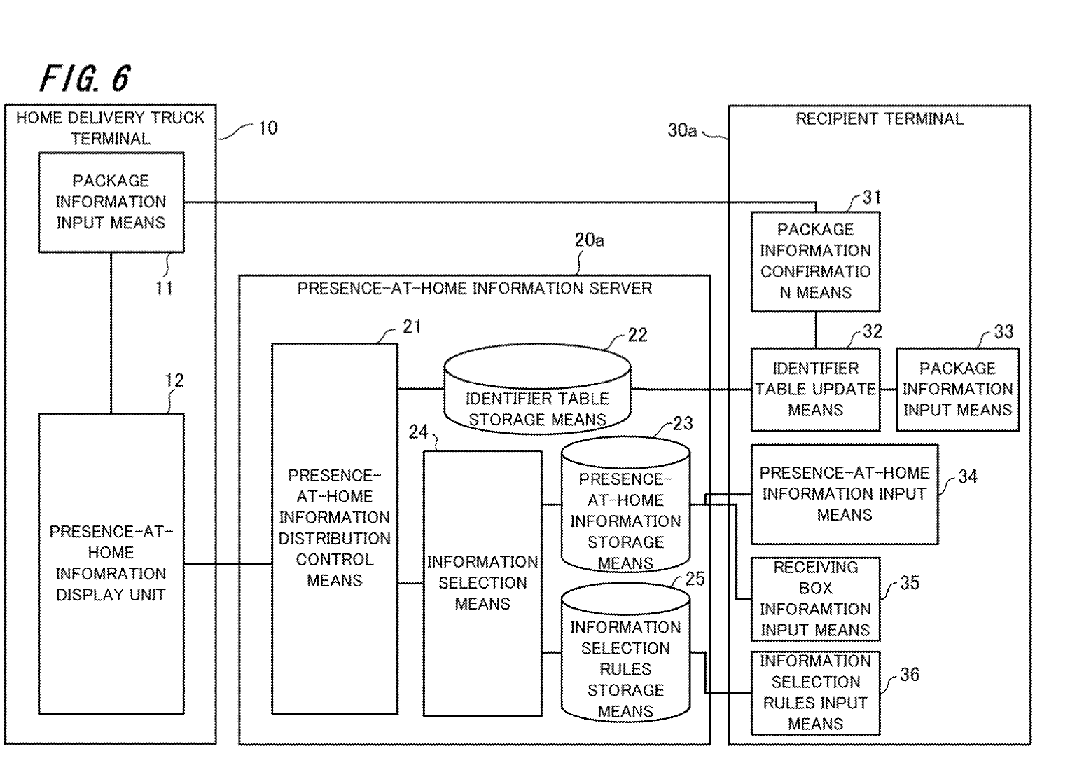

FIG. 6 illustrates the configuration of a presence-at-home acquisition system of a second embodiment of the present invention. In addition to the configuration of the presence-at-home information acquisition system of the first embodiment illustrated in FIG. 1, the configuration of the presence-at-home information acquisition system of this embodiment comprises: an information selection means 24, an information selection rules storage means 25, a receiving box information input means 35 and an information selection rules input means 36. In this embodiment, in addition to the recipient's presence-at-home information, alternate delivery method information (receiving box information) that indicates whether or not it is possible to use an alternate delivery method such as a receiving box is used.

The receiving box information input means 35 comprises an input device such as a sensor that is located on the receiving box, and receiving box information is inputted by using that input device. The receiving box information input means 35 stores receiving box information in the presence-at-home information storage means 23 of the presence-at-home information server 20a. When the input device detects that there is no package in the receiving box, for example, the receiving box information input means 35 registers information in the presence-at-home information storage means 23 as receiving box information for the recipient that is identified by the recipient identifier, and that information indicates that it is possible to use the receiving box. When there is a package in the receiving box, the receiving box information input means 35 updates the receiving box information in the presence-at-home information storage means 23 to indicate that the receiving box cannot be used.

The presence-at-home information storage means 23 receives at least one of presence-at-home information and receiving box information, and stores at least one of presence-at-home information and receiving box information for each recipient. In this embodiment, the presence-at-home information and the receiving box information are generally referred to as attributes. Attributes include an attribute name and attribute value. The attribute name indicates the type of information. Here, the attribute name ‘receiver’ is assigned to presence-at-home information, and the attribute name ‘receiving-box’ is assigned to receiving box information. The attribute value indicates whether or not it is possible to receive a visit, or whether or not it is possible to use the receiving box. Here, when the presence-at-home information indicates that it is possible for the recipient to receive a visit, or when the receiving box can be used, the attribute value is ‘available’. When the recipient cannot receive a visit, or when there is no receiving box or the receiving box cannot be used, the attribute value is ‘not-available’.

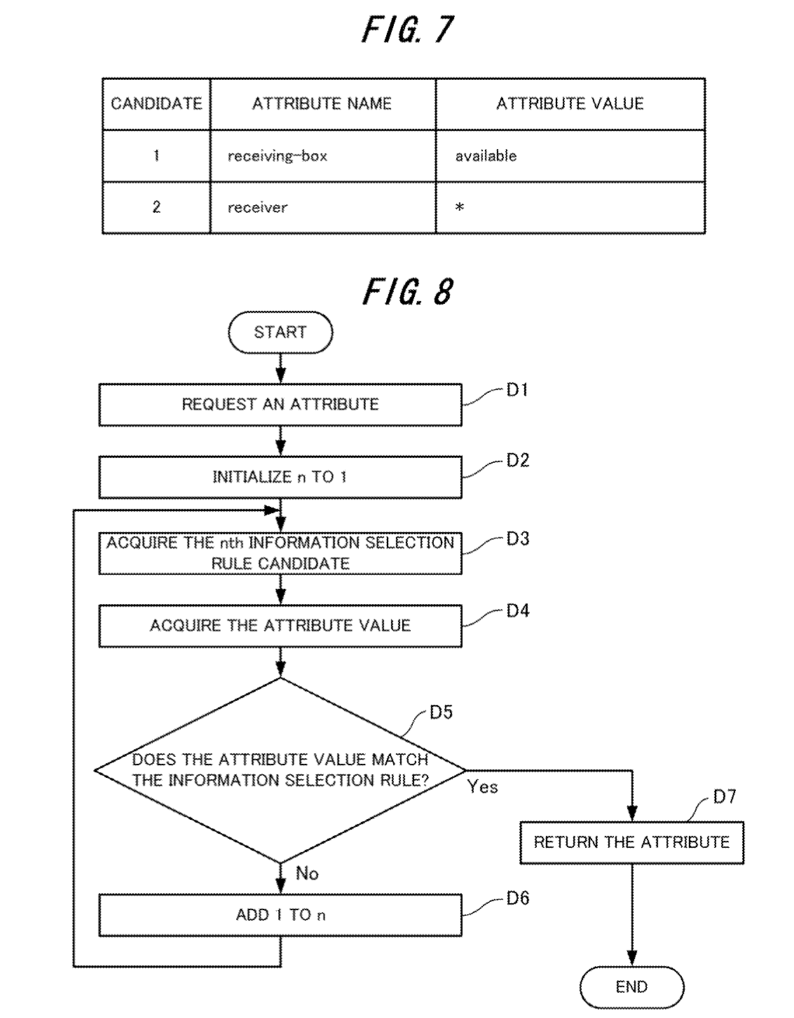

The information selection rules storage means 25 stores 0 or more information selection rules. The information selection rules are rules that regulate which information takes precedence when acquiring information from the presence-at-home information storage means 23. In other words, they are rules that regulate which information takes precedence when selecting presence-at-home information or receiving box information. The information selection rules include attribute names and attribute values. A detailed example of information selection rules is illustrated in FIG. 7. The candidate number indicates the priority of the information selection rule. The information selection rule of the first candidate comprises the attribute name ‘receiving-box’ and the attribute value ‘available’. This information selection rule means that when it is possible to use the receiving box, the receiving box information is selected. The second information selection rule candidate has the attribute name ‘receiver’ and attribute value ‘*’. This information selection rule means that regardless of the attribute value, the presence-at-home information will be selected. The information selection rules are read in order starting from the candidates with the smallest number, and rules of candidates with small numbers have priority. In the example of FIG. 7, the first candidate (attribute name ‘receiving-box’, attribute value ‘available’) that is stored in the information selection rules storage means 25 has priority over the second candidate (attribute name ‘receiver’, attribute value ‘*’).

The information selection rules input means 36 comprises an output device such as a liquid-crystal display, and an input device such as a keyboard or mouse. The information selection rules input means 36 displays information selection rules that were acquired from the information selection rules storage means 25 to the recipient by way of the output device. The recipient uses the input device to input information selection rules. When the recipient inputs an information selection rule, the information selection rules input means 36 adds and registers the inputted information selection rule to the information selection rules storage means 25. Alternatively, the information selection rules that are stored in the information selection rules storage means 25 are replaced by the information selection rules that were inputted by the recipient. When the recipient gives an instruction to delete an information selection rule that is stored in the information selection rules storage means 25, the information selection rules input means 36 deletes that information selection rule from the information selection rules storage means 25. When there is more than one alternate delivery method that can be used, the recipient registers attribute names that correspond to those alternate delivery methods and registers them in the information selection rules.

The presence-at-home information distribution control means 21 receives a display request from the presence-at-home display means 12 to display presence-at-home information. After receiving a display request to display presence-at-home information, the presence-at-home information distribution control means 21 specifies a recipient identifier, and sends a request to the information selection means 24 to acquire presence-at-home information. When the recipient identifier is received from the presence-at-home information distribution control means 21, the information selection means 24 acquires information selection rules from the information selection rules storage means 25 starting from the first candidate rule. Moreover, the information selection means 24 references the presence-at-home information storage, means 23 and acquires the attribute values that correspond to the attribute names that are included in the information selection rules for the recipient that is identified by the recipient identifier that was received from the presence-at-home information distribution control means 21. The information selection means 24 determines whether or not the acquired attribute values match any of the attribute values included in the information selection rules, and when there is a match, gives that attribute name and the attribute value acquired from the presence-at-home information storage means 23 to the presence-at-home information distribution control means 21.

Continuing, the operation of this embodiment will be explained. The operation of the recipient registering the recipient identifier in the identifier table storage means 22 is the same as the operation in the first embodiment that is illustrated in FIG. 3. In addition, the operation when deleting a recipient identifier from the identifier table storage means 22 is the same as the operation in the first embodiment illustrated in FIG. 5. The flow of the operation from when the driver generates a presence-at-home information acquisition request until presence-at-home information is displayed is also the same as the operation in the first embodiment illustrated in FIG. 4. However, in this embodiment, the details of the operation for acquiring presence-at-home information in step B3 of FIG. 4 differs from that of the first embodiment.

FIG. 8 illustrates the operating procedure when acquiring presence-at-home information. The presence-at-home information distribution control means 21 gives the recipient identifier to the information selection means 24, and requests the attribute names and attribute values corresponding to that recipient identifier (step D1). After receiving the recipient identifier, the information selection means 24 initializes the variable n to 1 (step D2), and acquires the nth information selection rule candidate from the information selection rules storage means 25 (step D3). The information selection means 24 acquires the attribute value that corresponds to the attribute name included in the information selection rule that was acquired in step D3 for the recipient that was identified by the recipient identifier received from the presence-at-home information storage means 23 in step D1 (step D4).

The information selection means 24 determines whether or not the attribute value acquired in step D4 matches the attribute value that is included in the information selection rule that was acquired in step D3 (step D5). For example, in step D3, when the first information selection rule candidate in FIG. 7 was acquired, in step D4, the information selection means 24 acquires the attribute value ‘available’ or ‘not-available’ for the attribute name ‘home-box’ from the presence-at-home information storage means 23, and determines whether or not the acquired attribute value matches the attribute value ‘available’ that was specified by the first candidate. In step D5, when it is determined that the attribute value does not match, the information selection means 24 adds 1 to the variable n (step D6), and then returns to step D3 and acquires the next information selection rule candidate.

In step, when it is determined that the attribute value matches, the information selection means 24 gives the attribute name and attribute value to the presence-at-home information distribution control means 21 (step D7). After receiving the attribute name and attribute value from the information selection means 24, the presence-at-home information distribution control means 21 sends the received attribute name and attribute value to the presence-at-home information display unit 12 of the delivery truck terminal 10. The presence-at-home information display unit 12 receives the attribute name and attribute value from the presence-at-home information distribution control means 21, and then using the output device, outputs that attribute name and attribute value and provides the driver with the presence-at-home information or receiving box information of the recipient.

In this embodiment, in addition to presence-at-home information, alternate delivery method information such as receiving box information is stored in the presence-at-home information storage means 23. The information selection means 24, in response to an acquisition request to acquire presence-at-home information, determines whether or not it is possible to use each of the alternate delivery methods according to the information selection rules that are stored in the information selection rules storage means 25, and when there is alternate delivery method information in the presence-at-home information storage means 23, returns that alternate delivery method information. By doing so, when there is an alternate delivery method such as a receiving box, the driver can be notified of the availability status of that alternate delivery method, making it possible to reduce the number of times and the amount time required to disclose the presence-at-home information of the recipient.

In this second embodiment, the recipient can rewrite the contents of the information selection rules storage means 25. This is advantageous in that it is possible to change the information for which priority is given according to the recipient. Moreover, this is also advantageous in that the recipient can change the information for which priority is given case-by-case according to the type of package. For example, in the case of a package that requires refrigeration, the recipient can store an information selection rule that will cause to select presence-at-home information in the information selection rules storage means 25 regardless of whether the presence-at-home information is ‘available’ or ‘not-available’. This makes it possible to prevent packages for which refrigeration is necessary from being placed in the receiving box. Furthermore, in the case where the package is heavy, an information selection rule that selects presence-at-home information is stored. By doing so, it will not be necessary for the recipient to carry the heavy package into the house from the receiving box. The other advantages are the same as in the first embodiment.

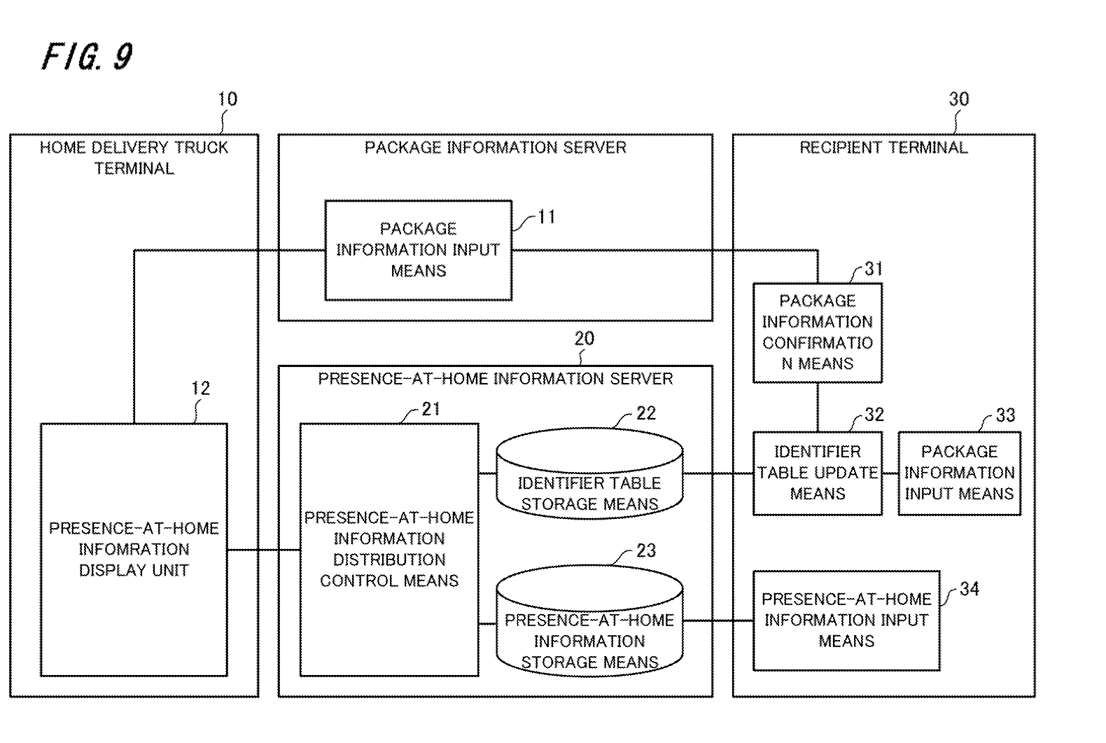

Each of the embodiments can undergo various changes. For example, in FIG. 1, the package information input means 11 that is located in the delivery truck terminal 10 can also be such that it is located outside of the delivery truck terminal 10. The configuration in that case is illustrated in FIG. 9. This configuration differs from the configuration illustrated in FIG. 1 in that the package information input means 11 is located inside a package information server 40 that is located at the distribution center of the delivery company. When this kind of configuration is employed, it is possible to prevent the input of improper package information by the driver. In addition, the presence-at-home information acquisition system can also be applied to something other than use in a delivery business. For example, the system can be applied to other uses that require visiting a home. In that case, for example, a presence-at-home information acquisition request that specifies a visit number is generated, and reference access to the presence-at-home information of a user can be controlled by whether or not a set of the visit number and a user identifier are stored in an identifier table storage means.

Moreover, in the second embodiment, a combination of attribute name and attribute value were used for the information selection rule; however, the configuration of the information selection rule is not limited to this. For example, it is possible to use just the attribute name for the information selection rule and omit the attribute value. In that case, an attribute name for which the attribute is ‘available’ is searched for in order starting from the first candidate, and when an ‘available’ attribute name is found, the alternate delivery method information that is indicated by that attribute name can be given to the presence-at-home information distribution control means 21. In addition, a plurality of information selection rules can be prepared to correspond to the type of package (refrigerated item, frozen item, heavy item, etc.). In that case, the information selection rule can be acquired using information that indicates the type of package, and presence-at-home information or alternate delivery method information for the recipient can be acquired according to the acquired information selection rule.

In the second embodiment, the information selection means 24 references the information selection rules storage means 25 and selects information to acquire from the presence-at-home information storage means 23; however, configuration is also possible in which the information selection rules storage means 25 is not used. In this case, the information selection means 24 can select information to acquire from the presence-at-home information storage means 23 in an order of priority that is fixed. A merit of using an information selection rules storage means 25 is that it is possible to be flexible in handling alternate delivery methods added by the recipient. Furthermore, in the second embodiment, the information selection means 24 selects and outputs either presence-at-home information or receiving box information; however, the embodiment is not limited to this. It is possible for the information selection means 24 to output both presence-at-home information and receiving box information.

In the embodiments described above, the delivery truck terminal acquires presence-at-home information from the presence-at-home information server for the purpose of displaying the presence-at-home information of the recipient on the presence-at-home display means 12; however, the use of the acquired presence-at-home information is not limited to being provided to the driver. For example, the acquired presence-at-home information of the recipient can also be used as information when planning a delivery route.

The present invention was explained with reference to special illustrative and exemplary embodiments; however, the invention is not limited to these embodiments or variations thereof. As is obvious to one skilled in the art, the present invention can be modified in various ways within the spirit and scope of the invention as stated in the accompanying claims.

This application claims priority based upon Japanese Patent Application No. 2007-338886 filed on Dec. 28, 2007, the entire disclosure thereof being incorporated herein by reference.

1. A presence-at-home information acquisition system comprising:
an identifier table update unit that, when the user performs input allowing acquisition of the user's presence-at-home information, correlates and stores a first identifier for identifying a user and a second identifier that is specified in an acquisition request for presence-at-home information in an identifier table storage unit that correlates and stores the first identifier and second identifier; and
a presence-at-home information distribution control unit that determines whether or not the second identifier is stored in the identifier table storage unit, and when it is determined that the second identifier is stored, acquires presence-at-home information from a presence-at-home information storage unit that stores the presence-at-home information of the user specified by the first identifier that corresponds to the second identifier.

2. The presence-at-home information acquisition system according to claim 1, further comprising
a confirmation unit that prompts the user to input information specifying whether or not to allow acquisition of the presence-at-home information.

3. The presence-at-home information acquisition system according to claim 2, further comprising
an information input unit that inputs the second identifier and sends that second identifier to the confirmation unit.

4. The presence-at-home information acquisition system according to claim 3, wherein
the information input unit creates a confirmation request that includes the second identifier, and sends that created confirmation request to the information confirmation unit.

5. The presence-at-home information acquisition system according to claim 1, wherein
the first identifier is a recipient identifier that identifies a recipient that will receive a package, and
the second identifier is a package identifier that identifies a package that the recipient is supposed to receive.

6. The presence-at-home information acquisition system according to claim 5, wherein
when a package identifier for a delivered package is inputted, the identifier table update unit deletes the package identifier of the delivered package from the identifier table storage unit.

7. The presence-at-home information acquisition system according to claim 5, wherein
the presence-at-home information storage unit further stores alternate delivery method information for one or more alternative delivery methods capable of receiving a package that indicates whether or not it is possible to use the alternate delivery method, and further comprises
an information selection unit that outputs at least one of the presence-at-home information and the alternate delivery method information to the presence-at-home information distribution control unit; wherein
the presence-at-home information distribution control unit acquires information that the information selection unit outputs.

8. The presence-at-home information acquisition system according to claim 7, wherein
the information selection unit acquires information selection rules from an information selection rules storage unit that stores information selection rules that specify rules for selecting information, and outputs at least one of the presence-at-home information and the alternate delivery method information based on the acquired information selection rules.

9. The presence-at-home information acquisition system according to claim 8, wherein
the information selection rule includes an attribute name and attribute value that describe each type of information; and
the information selection unit acquires information of each information type indicated by the attribute name of the information selection rule from the presence-at-home information storage unit, compares the contents of the acquired information with the attribute value of the information selection rule, and outputs the information of each information type when both match.

10. The presence-at-home information acquisition system according to claim 9, wherein
the information selection rules include a plurality of condition candidates for which an order of priority is set; and
the information selection unit selects the condition candidates from the information selection rules storage unit in order of highest priority, and compares the contents of information acquired from the presence-at-home information storage unit with the attribute values of the selected condition candidates.

11. A recipient terminal comprising:
an information confirmation unit that prompts a user to input information that specifies whether or not to allow acquisition of presence-at-home information; and
an identifier table update unit that, when the user performs input allowing acquisition of the user's presence-at-home information, correlates and stores a first identifier for identifying a user and a second identifier that is specified in an acquisition request for presence-at-home information in an identifier table storage unit that correlates and stores the first identifier and second identifier.

12. The recipient terminal according to claim 11, wherein
the first identifier is a recipient identifier that identifies a recipient that will receive a package,
the second identifier is a package identifier that identifies a package that the recipient is supposed to receive, and
when the package identifier of a delivered package is inputted, the identifier table update unit deletes the package identifier of the delivered packages from the identifier table storage unit.

13. A presence-at-home information server comprising a presence-at-home distribution control unit that determines whether or not a second identifier is stored in an identifier table storage unit that correlates and stores a first identifier for identifying a user and a second identifier that is specified in an acquisition request for presence-at-home information, and when it is determined that the second identifier is stored, acquires presence-at-home information of the user identified by the first identifier that corresponds to the second identifier from a presence-at-home information storage unit that stores the presence-at-home information of the user.

14. A method of using a computer to provide presence-at-home information that indicates whether a user can receive a visit, the presence-at-home information provision method comprising the steps of:
the computer correlating and storing a first identifier for identifying the user, and a second identifier that is specified by an acquisition request for presence-at-home information in an identifier table storage unit when the user performs input allowing the acquisition of the presence-at-home information;
the computer determining whether or not the second identifier is stored in the identifier table storage unit; and
the computer acquiring presence-at-home information from the presence-at-home information storage unit, which stores the presence-at-home information, of the user identified by the stored first identifier that corresponds to the second identifier when it is determined in the judgment step that the second identifier is stored.

15. The presence-at-home information provision method according to claim 14, wherein
the first identifier is a recipient identifier that identifies a recipient that will receive a package,
the second identifier is a package identifier that identifies the package that the recipient is to receive,
the presence-at-home information storage unit further stores alternate delivery method information for one or more alternative delivery methods capable of receiving a package that indicates whether or not it is possible to use the alternate delivery method, and
in the steps of acquiring the presence-at-home information, acquires an information selection rule from an information selection rule storage unit that stores information selection rules that specify rules for selecting information, and acquires at least one of the presence-at-home information and the alternate delivery method information from the presence-at-home information storage unit based on the acquired information selection rule.

16. A recording medium storing a program for providing presence-at-home information that indicates whether a user can receive a visit, and that causes a computer to execute the processes of:
correlating and storing a first identifier for identifying the user, and a second identifier that is specified by an acquisition request for presence-at-home information in an identifier table storage unit when the user performs input allowing the acquisition of the presence-at-home information;
determining whether or not the second identifier is stored in the identifier table storage unit; and
acquiring presence-at-home information from the presence-at-home information storage unit, which stores the presence-at-home information, of the user identified by the stored first identifier that corresponds to the second identifier when it is determined in the judgment step that the second identifier is stored.

17. The recording medium according to claim 16, wherein
the first identifier is a recipient identifier that identifies a recipient that will receive a package,
the second identifier is a package identifier that identifies the package that the recipient is to receive,
the presence-at-home information storage unit further stores alternate delivery method information for one or more alternative delivery methods capable of receiving a package that indicates whether or not it is possible to use the alternate delivery method, and
in the steps of acquiring the presence-at-home information, causes a computer to acquire an information selection rule from an information selection rule storage unit that stores information selection rules that specify rules for selecting information, and acquire at least one of the presence-at-home information and the alternate delivery method information from the presence-at-home information storage unit based on the acquired information selection rule.
